(19) United States
(12) Patent Application Publication
(10) Pub. No.: US 2025/0265804 A1
(43) Pub. Date: Aug. 21, 2025

(54) INFORMATION PROCESSING SYSTEM, INFORMATION PROCESSING METHOD, AND NON-TRANSITORY COMPUTER READABLE MEDIUM

(71) Applicant: NEC Corporation, Minato-ku,Tokyo (JP)

(72) Inventors: Yuho SHOJI, Tokyo (JP); Takahiro Toizumi, Tokyo (JP)

(73) Assignee: NEC Corporation, Minato-ku,Tokyo (JP)

(21) Appl. No.: 18/857,270

(22) PCT Filed: Aug. 30, 2022
(86) PCT No.: PCT/JP2022/032672

§ 371 Date: Oct. 16, 2024

(51) Int. Cl. G06V 10/32; G06T 3/4053; G06T 3/60; G06T 5/73; G06V 10/44; G06V 10/82; G06V 40/18

(52) U.S. Cl. CPC G06V 10/32; G06T 3/4053; G06T 3/60; G06T 5/73; G06V 10/44; G06V 10/82; G06V 40/18

(57) ABSTRACT

An information processing system (100) includes a first processing unit (102), a normalization unit (103), a second processing unit (104), and a correction unit (105). The first processing unit (102) performs first processing using a first neural network with a subject image as an input. The normalization unit (103) performs normalization processing using first output information being a result of the first processing, and generates a normalized image relating to the subject image. The second processing unit (104) performs second processing using a second neural network with the normalized image as an input, and extracts an image feature relating to the normalized image. The correction unit 105 corrects, based on information relating to the normalized image, a first parameter being a parameter used in the first neural network.

### TECHNICAL FIELD

The present invention relates to an information processing system, an information processing method, and a storage medium.

### BACKGROUND ART

For example, Patent Document 1 discloses an image processing method that can distinguish and recognize, by an iris feature being associated with an iris image, whether a subject corresponding to the iris image is the same subject, for example, an iris image of the same person subject.

Patent Document 1 has a description that an iris position, a pupil position, and an associated iris image may be input to a neural network that executes iris division, and the neural network may output a mask map being associated with an iris region in the iris image. The neural network that executes the iris division can determine an iris region in an iris image by training, and generate an associated mask map.

Moreover, according to the description in Patent Document 1, there is a possibility that an acquired iris image and a mask map of a detected iris region are different in size. Thus, Patent Document 1 has a description that, once the iris position and a mask map (division result) of the iris region in the iris image is acquired, the image region associated with the iris position and the mask map may be subjected to normalization processing, and the normalized image region and the mask map may be adjusted to a previously set standard.

Further, Patent Document 1 has a description that multi-scale feature processing on an image region being associated with a normalized iris position may be executed, and feature performance is further enhanced. According to the description in Patent Document 1, the multi-scale feature processing is a similar processing procedure to multi-scale feature extraction, and can acquire an iris feature map being associated with an iris image by executing multi-scale feature extraction and the like.

### Related Document

### Patent Document

Patent Document 1: Japanese Patent Application Publication (Translation of PCT Application) No. 2022-511217

### SUMMARY

### Technical Problem

The disclosure has an object to improve a technique described in a related document described above.

### Solution to Problem

According to one aspect of the present invention, there is provided an information processing system including:
a first processing means that performs first processing using a first neural network with a subject image as an input;
a normalization means that performs normalization processing using first output information being a result of the first processing, and generates a normalized image relating to the subject image;
a second processing means that performs second processing using a second neural network with the normalized image as an input, and extracts an image feature relating to the normalized image; and
a correction means that corrects, based on information relating to the normalized image, a first parameter being a parameter used in the first neural network.

According to one aspect of the present invention, there is provided an information processing method including,
by one or more computers:
performing first processing using a first neural network with a subject image as an input;
performing normalization processing using first output information being a result of the first processing, and generating a normalized image relating to the subject image;
performing second processing using a second neural network with the normalized image as an input, and extracting an image feature relating to the normalized image; and
correcting, based on information relating to the normalized image, a first parameter being a parameter used in the first neural network.

According to one aspect of the present invention, there is provided a medium recording a program for causing one or more computers to execute:
performing first processing using a first neural network with a subject image as an input;
performing normalization processing using first output information being a result of the first processing, and generating a normalized image relating to the subject image;
performing second processing using a second neural network with the normalized image as an input, and extracting an image feature relating to the normalized image; and
correcting, based on information relating to the normalized image, a first parameter being a parameter used in the first neural network.

### BRIEF DESCRIPTION OF THE DRAWINGS

FIG. 1 is a diagram illustrating an outline of an information processing system according to a first example embodiment.

FIG. 2 is a flowchart illustrating an outline of information processing according to the first example embodiment.

FIG. 3 is a diagram illustrating a configuration example of an information processing system according to the first example embodiment.

FIG. 4 is a diagram illustrating one example of a subject image according to the first example embodiment.

FIG. 5 is a diagram illustrating one example of expansion processing according to the first example embodiment.

FIG. 6 is a diagram illustrating a physical configuration example of an information processing apparatus according to the first example embodiment.

FIG. 7 is a flowchart illustrating a detailed example of correction processing according to the first example embodiment.

FIG. 8 is a diagram for describing processing of deriving a first loss gradient, based on a second loss gradient and a normalized gradient, in the first example embodiment.

FIG. 9 is a diagram illustrating a functional configuration example of a parameter correction unit according to a second example embodiment.

FIG. 10 is a flowchart illustrating a detailed example of parameter correction processing according to the second example embodiment.

FIG. 11 is a diagram illustrating a configuration example of an information processing system according to a third example embodiment.

FIG. 12 is a flowchart illustrating one example of information processing for recognition according to the third example embodiment.

FIG. 13 is a diagram illustrating a configuration example of an information processing system according to a fourth example embodiment.

FIG. 14 is a diagram illustrating a configuration example of an information processing system according to a sixth example embodiment.

FIG. 15 is a diagram illustrating a functional configuration example of a normalization unit according to the sixth example embodiment.

FIG. 16 is a flowchart illustrating one example of information processing according to the sixth example embodiment.

FIG. 17 is a flowchart illustrating one example of normalization processing according to the sixth example embodiment.

### EXAMPLE EMBODIMENT

Hereinafter, example embodiments of the present invention are described by use of the drawings. Note that, a similar reference sign is assigned to a similar component in all the drawings, and description is omitted as appropriate.

### First Example Embodiment

### (Outline)

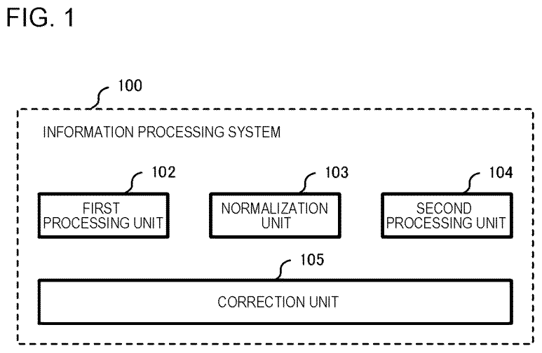

FIG. 1 is a diagram illustrating an outline of an information processing system 100 according to a first example embodiment. The information processing system 100 includes a first processing unit 102, a normalization unit 103, a second processing unit 104, and a correction unit 105.

The first processing unit 102 performs first processing using a first neural network with a subject image as an input.

The normalization unit 103 performs normalization processing using first output information being a result of the first processing, and generates a normalized image relating to the subject image.

The second processing unit 104 performs second processing using a second neural network with the normalized image as an input, and extracts an image feature relating to the normalized image.

The correction unit 105 corrects, based on information relating to the normalized image, a first parameter being a parameter used in the first neural network.

According to the information processing system 100, a first parameter is corrected based on information relating to a normalized image. Thus, the first parameter can be corrected, by utilizing a chain rate of a partial differential, in such a way as to reduce a loss derived by use of a common loss function for the first neural network and the second neural network. Since machine learning of the first neural network and the second neural network can be performed simultaneously by use of a common loss function, the first parameter can be corrected in such a way that an image feature suitable for recognition can be extracted. Therefore, it becomes possible to improve performance of recognition using a subject image.

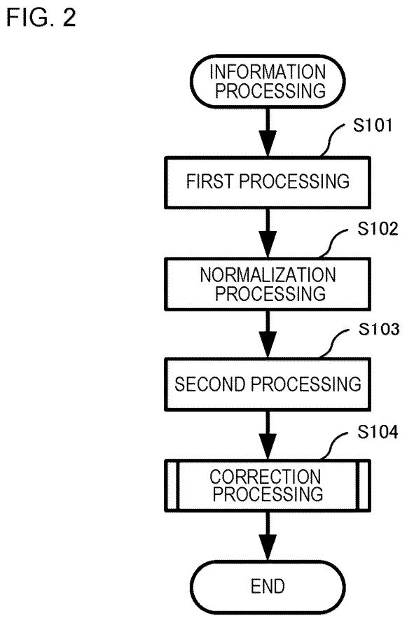

FIG. 2 is a flowchart illustrating an outline of information processing according to the first example embodiment.

The first processing unit 102 performs first processing using a first neural network with a subject image as an input (step S101).

The normalization unit 103 performs normalization processing using first output information being a result of the first processing, and generates a normalized image relating to the subject image (step S102).

The second processing unit 104 performs second processing using a second neural network with the normalized image as an input, and extracts an image feature relating to the normalized image (step S103).

The correction unit 105 corrects, based on information relating to the normalized image, a first parameter being a parameter used in the first neural network (step S104).

According to the information processing, a first parameter is corrected based on information relating to a normalized image. Thus, the first parameter can be corrected, by utilizing a chain rate of a partial differential, in such a way as to reduce a loss derived by use of a common loss function for the first neural network and the second neural network. Since machine learning of the first neural network and the second neural network can be performed simultaneously by use of a common loss function, the first parameter can be corrected in such a way that an image feature suitable for recognition can be extracted. Therefore, it becomes possible to improve performance of recognition using a subject image.

A detailed example of the first example embodiment is described below.

### Detailed Example

For example, an image processing method described in Patent Document 1 described above uses a neural network that executes iris division. Moreover, generally, a neural network is also often used in processing of acquiring an iris feature map (multi-scale feature processing).

In this way, in order to perform recognition using a subject image (iris image in Patent Document 1), the recognition may be sequentially performed by connecting a plurality of different neural networks, and it is required to improve performance of recognition using a subject image. In view of the circumstances, one example of an object of this disclosure is to provide an information processing system, an information processing method, a medium, and the like that solve improving performance of recognition using a subject image.

Herein, “recognition using a subject image” means confirming reliability, validity, and the like of a subject shown in the subject image. Recognition using a subject image is performed, for example, by discerning whether a subject shown in the subject image is the same as a predetermined subject (e.g., whether a person shown in an iris image is the same as a previously registered person).

### (Functional Configuration Example of Information Processing System 100)

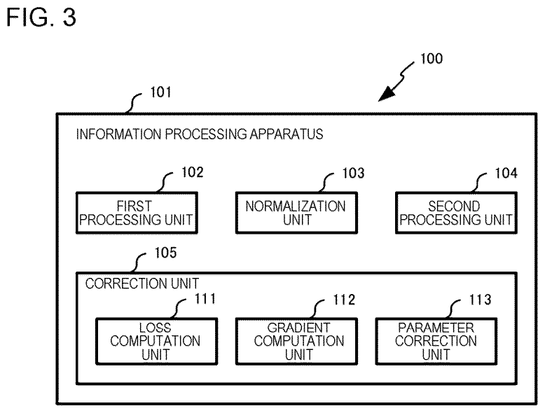

FIG. 3 is a diagram illustrating a configuration example of the information processing system 100 according to the first example embodiment. The information processing system 100 includes an information processing apparatus 101. The information processing apparatus 101 functionally includes the first processing unit 102, the normalization unit 103, the second processing unit 104, and the correction unit 105.

The first processing unit 102 performs first processing using a first neural network with a subject image as an input. The subject image is an image acquired by capturing a subject. The first processing unit 102 outputs first output information being a result of the first processing.

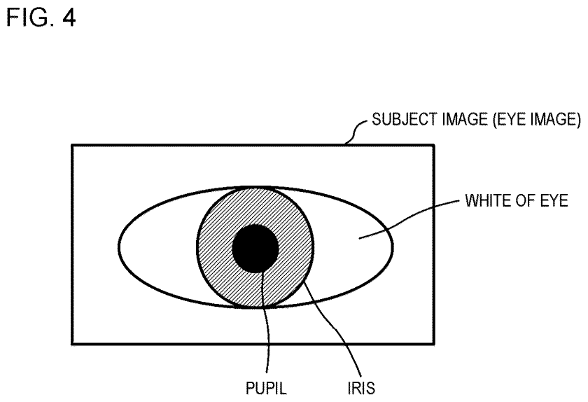

FIG. 4 is a diagram illustrating one example of a subject image according to the first example embodiment. In the present example embodiment, a subject is a human eye, and the subject image is an eye image capturing the human eye. The eye image is an image illustrating the eye, and includes, for example, one or a plurality of images of a pupil, an iris, a white of the eye, and the like.

Note that, a subject image is not limited to an eye image, and may be, for example, a face image capturing a face being a subject (i.e., an image showing a face), an image capturing an object being a subject, or the like. Moreover, an eye image and a face image are not limited to those of a human, and may be an image showing an eye and a face of an animal. In a case where a subject image is an eye image, iris recognition can be performed. In a case where a subject image is a face image, face recognition can be performed. In this way, recognition according to a subject image (e.g., various types of biometric recognition) can be performed.

For example, an appropriate neural network such as a convolutional neural network may be adopted as the first neural network.

The first processing unit 102 preferably acquires a subject image in order to input the subject image to the first neural network. There are various methods for the first processing unit 102 to acquire a subject image. For example, the first processing unit 102 may acquire the subject image from a camera (not illustrated). For example, the first processing unit 102 may acquire the subject image from another apparatus (not illustrated) via a network. For example, the first processing unit 102 may acquire a subject image from a storage unit (not illustrated) that is built in or connected to outside.

The first processing is, for example, processing for detecting a previously determined keypoint regarding a subject in a subject image. First output information in this case is information relating to the keypoint (keypoint information).

In the present example embodiment, description is given by use of an example in which the first processing is eye detection processing for detecting an iris in an eye image. Keypoints according to the present example embodiment are, for example, an iris and a pupil.

The first output information according to the present example embodiment includes, as keypoint information, a position of an iris (iris position) detected in the first processing. The iris position includes, for example, a pupil center position, a pupil radius, an iris center position, and an iris radius.

The pupil center position is information indicating a position of a pupil center. The pupil radius is information indicating a radius of a pupil. The iris center position is information indicating a position of an iris center. The iris radius is information indicating a radius of an iris.

Note that, the first processing is not limited to the eye detection processing, and may be various types of processing. An example of the first processing other than the eye detection processing is described in another example embodiment. Moreover, the keypoint is not limited to a pupil or an iris, and may be, for example, an outer corner of an eye, an inner corner of an eye, or the like. Keypoint information regarding each of the outer corner and inner corner of the eye is, for example, each of information indicating a position of the outer corner of the eye and information indicating a position of the inner corner of the eye.

The normalization unit 103 performs normalization processing using first output information being a result of the first processing, and generates a normalized image relating to the subject image. The normalization unit 103 according to the present example embodiment performs normalization processing using a position of an iris detected in the first processing, and generates a normalized image relating to the iris included in an eye image.

The normalization processing may include, for example, processing of nonlinearly normalizing a subject image (nonlinear normalization processing). The nonlinear normalization processing may be, for example, an expansion processing of converting an annular image into a rectangular image. The annular image is an image surrounded by two approximately concentric circles. In the nonlinear normalization processing in this case, for example, processing of converting a polar coordinate system into an orthogonal coordinate system may be performed on the annular image.

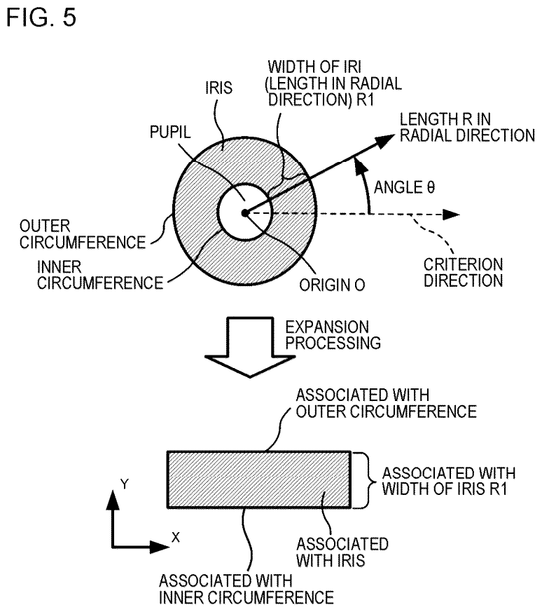

FIG. 5 is a diagram illustrating one example of expansion processing according to the first example embodiment. The annular image according to the present example embodiment is, for example, an image of an iris. In this case, in the expansion processing, processing of converting, into an XY coordinate system, a polar coordinate system formed of a length R in a radial direction with an iris center as an origin, and an angle θ formed by a criterion direction and a radius is performed on an iris image.

In this case, in the normalization processing, the normalization unit 103 cuts out an image of the iris from a subject image, based on first output information, and performs expansion processing on the image of the iris. As a result, the normalization unit 103 generates a normalized image relating to the subject image.

The second processing unit 104 performs second processing using a second neural network with the normalized image as an input, and extracts an image feature relating to the normalized image. The image feature is preferably used for, for example, recognition.

For example, an appropriate neural network such as a convolutional neural network may be adopted as the second neural network.

The correction unit 105 corrects the first parameter, based on information relating to the normalized image. The correction unit 105 may further correct a second parameter.

The information relating to the normalized image includes, for example, a normalized gradient. The normalized gradient is a local gradient in normalization processing.

The first parameter is a parameter used in the first neural network. There are usually a plurality of first parameters, but there may be one first parameter.

The second parameter is a parameter used in the second neural network. There are usually a plurality of second parameters, but there may be one second parameter.

Specifically, for example, the correction unit 105 functionally includes a loss computation unit 111, a gradient computation unit 112, and a parameter correction unit 113.

The loss computation unit 111 derives a loss function for computing a loss based on an extracted image feature and correct answer data.

Specifically, the loss computation unit 111 acquires correct answer data, based on an instruction or the like of a user. The correct answer data are preferably previously prepared. There are various methods for the loss computation unit 111 to acquire correct answer data. For example, the loss computation unit 111 may acquire correct answer data from another apparatus (not illustrated) via a network. For example, the loss computation unit 111 may acquire correct answer data from a storage unit (not illustrated) that is built in or connected to outside.

The loss computation unit 111 derives a loss function for computing an error (loss) between the image feature and the correct answer data. For example, cross entropy (error), mean square error, or the like is preferably applied to the error (loss).

The gradient computation unit 112 derives a normalized gradient, based on the normalized image. For example, the gradient computation unit 112 computes a normalized gradient, based on the normalized image, in such a way that a loss is reduced. The loss is a value that can be computed by use of a loss function derived by the loss computation unit 111.

The gradient computation unit 112 according to the present example embodiment may further derive at least one of a second gradient and a first gradient in such a way that a loss is reduced.

The second gradient is a local gradient in the second neural network. The gradient computation unit 112 derives a second gradient at each node forming the second neural network, for example, based on information relating to the second neural network.

The first gradient is a local gradient in the first neural network. The gradient computation unit 112 derives, for example, based on information relating to the first neural network, a first gradient at each node forming the first neural network.

The parameter correction unit 113 corrects the first parameter, based on the normalized gradient. The parameter correction unit 113 may further derive a first loss gradient and a second loss gradient. The parameter correction unit 113 may further correct the second parameter, based on the second gradient.

The first loss gradient is a gradient of a loss function for being applied to the first neural network. In other words, the first loss gradient is a gradient (∂L/∂x) of a loss function L regarding a first parameter x. The second loss gradient is a gradient of a loss function for being applied to the second neural network. In other words, the second loss gradient is the gradient (∂L/∂y) of the loss function L regarding a second parameter y.

Herein, L represents a loss function. x is a parameter applied to the first neural network. y is a parameter applied to the second neural network.

Specifically, for example, the parameter correction unit 113 corrects the second parameter, based on a gradient of the loss function L and the second gradient. The parameter correction unit 113 preferably uses, for example, an error backpropagation method in order to correct the second parameter.

Moreover, for example, the parameter correction unit 113 derives the second loss gradient (∂L/∂y) by use of, for example, an error backpropagation method. The parameter correction unit 113 derives the first loss gradient (∂L/∂x), for example, based on the second loss gradient (∂L/∂y) and a normalized gradient (∂y/∂x).

The parameter correction unit 113 corrects the first parameter, based on the first loss gradient (∂L/∂x) and the first gradient. The parameter correction unit 113 preferably uses, for example, an error backpropagation method in order to correct the first parameter. Herein, the first loss gradient is derived based on the normalized gradient, as described above. Therefore, the parameter correction unit 113 corrects the first parameter, based on the normalized gradient.

(Physical configuration of information processing system 100)

The information processing system 100 according to the present example embodiment is physically formed of an information processing apparatus 101 that is formed of, for example, one personal computer (PC).

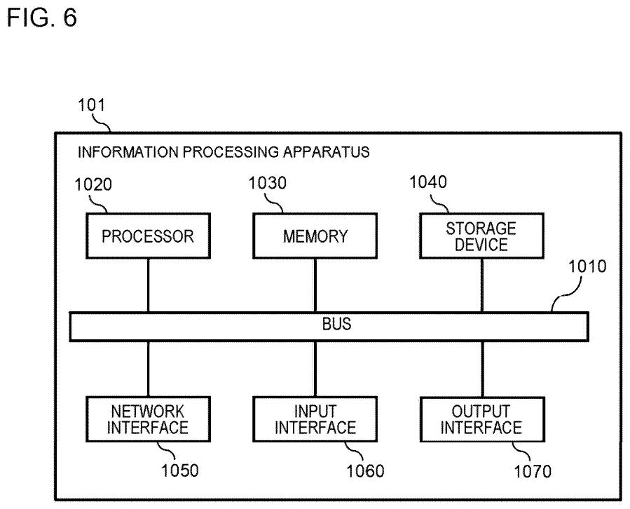

FIG. 6 is a diagram illustrating a physical configuration example of the information processing apparatus 101 according to the first example embodiment. The information processing apparatus 101 includes a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 transmit/receive data to/from each other. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function of the information processing apparatus 101. The processor 1020 reads each of the program modules onto the memory 1030, executes the read program module, and thereby achieves each function associated with the program module.

The network interface 1050 is an interface for connecting the information processing apparatus 101 to a network N formed wiredly, wirelessly, or by a combination thereof.

The input interface 1060 is an interface for a user to input information, and is formed of, for example, a touch panel, a keyboard, a mouse, and the like.

The output interface 1070 is an interface for presenting information to a user, and is made up of, for example, a liquid crystal panel, an organic electro-luminescence (EL) panel, and the like.

Note that, the information processing apparatus 101 may be physically formed of a plurality of apparatuses (e.g., computers) having a physical configuration illustrated in FIG. 6. In this case, the plurality of apparatuses are preferably connected in such a way that the apparatuses can transmit and receive information to and from each other, for example, wiredly, wirelessly, or via a network formed by a combination thereof.

### (Operation of Information Processing System 100)

As described above with reference to FIG. 2, the information processing system 100 executes information processing. Specifically, the information processing apparatus 101 executes information processing.

In the information processing, the information processing apparatus 101 performs machine learning of the first neural network by use of a subject image and correct answer data. In the information processing according to the present example embodiment, the information processing apparatus 101 further performs machine learning of the second neural network by use of the subject image and correct answer data. For example, the information processing apparatus 101 receives a previously determined start instruction from a user, and, thereby, information processing is started.

The first processing unit 102, the normalization unit 103, and the second processing unit 104 execute steps S101, S102, and S103, respectively. Then, as described above, the correction unit 105 corrects, based on information relating to a normalized image, the first parameter being a parameter used in the first neural network (step S104).

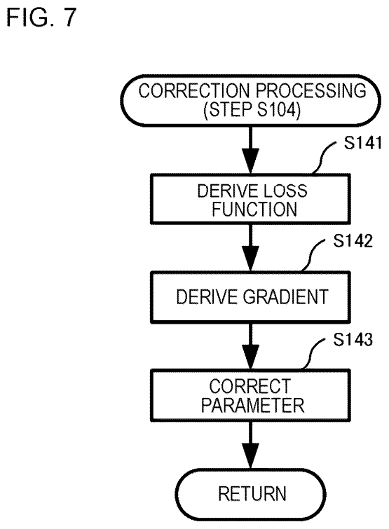

FIG. 7 is a flowchart illustrating a detailed example of correction processing (step S104) according to the first example embodiment.

The loss computation unit 111 derives a loss function for computing a loss based on an extracted image feature and correct answer data (step S141).

Specifically, for example, the loss computation unit 111 acquires previously prepared correct answer data, based on an instruction or the like of a user. The loss computation unit 111 derives a loss function for computing an error (loss) between the image feature and the correct answer data.

The gradient computation unit 112 derives a gradient in such a way that a loss acquired from the loss function derived in step S141 is reduced (step S142).

Specifically, for example, the gradient computed in step S142 includes a second gradient, a normalized gradient, and a first gradient.

The parameter correction unit 113 corrects the parameter by use of the gradient derived in step S142 (step S143).

Parameters corrected in step S143 according to the present example embodiment are, for example, the first parameter and the second parameter. Specifically, for example, the parameter correction unit 113 derives, by use of the gradient acquired in step S142, a first update value and a second update value such that a loss is reduced. The first update value is a value for updating the first parameter. The second update value is a value for updating the second parameter. The parameter correction unit 113 updates the first parameter and the second parameter by use of the first update value and the second update value, respectively.

More specifically, for example, the parameter correction unit 113 derives, based on a gradient of the loss function L and the second gradient, a second update value and a second loss gradient (∂L/∂y) such that a loss is reduced.

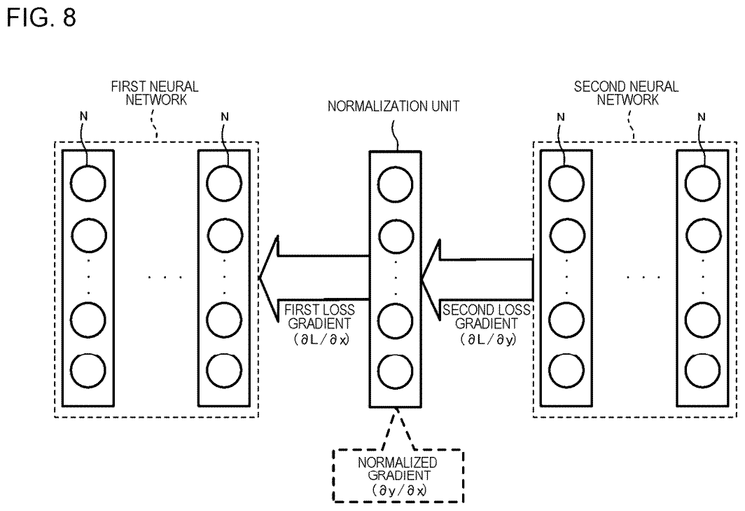

The parameter correction unit 113 derives, based on the second loss gradient (∂L/∂y) and the normalized gradient (∂y/∂x), a first loss gradient (∂L/∂x) such that a loss is reduced. FIG. 8 is a diagram for describing processing of deriving a first loss gradient, based on a second loss gradient and a normalized gradient. FIG. 8 illustrates an example in which the first neural network and the second neural network are formed of a plurality of nodes N. The parameter correction unit 113 derives, for example, a product of the normalized gradient (∂y/∂x) derived based on the normalized image, and the second loss gradient (∂L/∂y). Thereby, the gradient computation unit 112 derives the first loss gradient (∂L/∂x).

The parameter correction unit 113 derives, based on the first loss gradient (∂L/∂x) and the first gradient, a first update value such that a loss is reduced.

After executing step S143, the parameter correction unit 113 returns to the information processing (see FIG. 2), and ends the information processing.

In this way, by deriving the first loss gradient, based on the second loss gradient and the normalized gradient, the first parameter and the second parameter can be updated simultaneously (in an end-to-end way) by use of a common loss function between the first neural network and the second neural network.

### (Advantageous Effect)

As described above, according to the present example embodiment, the information processing system 100 includes the first processing unit 102, the normalization unit 103, the second processing unit 104, and the correction unit 105. The first processing unit 102 performs first processing using a first neural network with a subject image as an input. The normalization unit 103 performs normalization processing using the first output information being a result of the first processing, and generates a normalized image relating to the subject image. The second processing unit 104 performs second processing using a second neural network with the normalized image as an input, and extracts an image feature relating to the normalized image. The correction unit 105 corrects, based on information relating to the normalized image, a first parameter being a parameter used in the first neural network.

In this way, the first parameter is corrected based on information relating to the normalized image. Thus, the first parameter can be corrected, by utilizing a chain rate of a partial differential, in such a way as to reduce a loss derived by use of a common loss function for the first neural network and the second neural network. Since machine learning of the first neural network and the second neural network can be performed simultaneously by use of a common loss function, the first parameter can be corrected in such a way that an image feature suitable for recognition can be extracted. Therefore, it becomes possible to improve performance of recognition using a subject image.

According to the present example embodiment, the normalization processing includes processing of nonlinearly normalizing the subject image.

Thereby, an image suitable for extracting an image feature can be acquired. Thereby, an image feature suitable for recognition can be extracted. Therefore, it becomes possible to improve performance of recognition using a subject image.

According to the present example embodiment, information relating to a normalized image includes a normalized gradient being a local gradient in normalization processing. The correction unit 105 includes the gradient computation unit 112 that derives a normalized gradient, based on the normalized image, and the parameter correction unit 113 that performs the first parameter, based on the normalized gradient.

Thereby, as described above, since machine learning of the first neural network and the second neural network can be performed simultaneously by use of a common loss function, the first parameter can be corrected in such a way that an image feature suitable for recognition can be extracted. Therefore, it becomes possible to improve performance of recognition using a subject image.

According to the present example embodiment, the parameter correction unit 113 further corrects a second parameter being a parameter used in the second neural network, based on a second gradient being a local gradient in the second neural network.

Thereby, the first parameter and the second parameter can be corrected simultaneously (in an end-to-end way) by utilizing a chain rate of a partial differential, in such a way as to reduce a loss derived by use of a common loss function for the first neural network and the second neural network. Since machine learning of the first neural network and the second neural network can be performed simultaneously by use of a common loss function, the first parameter and the second parameter can be corrected simultaneously in such a way that an image feature suitable for recognition can be extracted. Therefore, it becomes possible to improve performance of recognition using a subject image.

According to the present example embodiment, the correction unit 105 further includes the loss computation unit 111 that computes a loss function for computing a loss based on an extracted image feature and correct answer data. The gradient computation unit 112 derives a normalized gradient, based on the normalized image, in such a way that a loss is reduced.

Thereby, as described above, since machine learning of the first neural network and the second neural network can be performed simultaneously by use of a common loss function, the first parameter can be corrected in such a way that an image feature suitable for recognition can be extracted. Therefore, it becomes possible to improve performance of recognition using a subject image.

According to the present example embodiment, a subject image is an eye image capturing an eye. The first processing is eye detection processing for detecting an iris in the eye image.

Thereby, a parameter (first parameter) used in the eye detection processing can be corrected in such a way that an image feature suitable for iris recognition is acquired. Therefore, it becomes possible to improve performance of recognition using a subject image.

According to the present example embodiment, the first output information includes a position of a detected iris. The normalization unit 103 performs normalization processing using the position of the detected iris, and generates a normalized image relating to the iris included in an eye image.

Thereby, a normalized image suitable for iris recognition can be acquired. Therefore, it becomes possible to improve performance of recognition using a subject image.

### First Modified Example

In the first example embodiment, description has been given by use of an example in which normalization processing includes processing of cutting out an image of an iris (cutout processing) and an expansion processing. However, the normalization processing is not limited thereto.

The normalization processing includes, for example, at least one of (1) expansion processing, (2) cutout processing, (3) scale conversion processing, (4) parallel movement processing, (5) rotation processing, (6) size change processing, (7) inversion processing, and (8) shear processing. An image to be a subject of each piece of processing may be a subject image, or may be a region-of-interest image showing a previously determined part, place, or the like.

(1) As described in the first example embodiment, the expansion processing is processing of converting an annular image into a rectangular image.

(2) The cutout processing is processing of cutting out an image of a region of interest from an image. In the cutout processing according to the first example embodiment, processing of cutting out an image of an iris is an example of cutout processing in a case where the iris is a region of interest, and can be performed by use of an iris center position and an iris diameter.

(3) The scale conversion processing is processing of converting an image in such a way that a length of a previously determined place has a predetermined relationship in relation to the image. For example, the scale conversion processing is processing of converting, by use of a pupil center position, a pupil radius, an iris center position, and an iris radius, an image in such a way that the pupil radius and the iris radius have a predetermined relationship (e.g., a previously determined ratio).

(4) The parallel movement processing is processing of moving an image in parallel. For example, the parallel movement processing is processing of moving, in parallel, an image of an iris determined by use of an iris center position and a radius.

(5) The rotation processing is processing of rotating an image. For example, the rotation processing is processing of rotating an eye image by use of position information of an outer corner and an inner corner of an eye in a subject image in such a way that the outer corner and inner corner of the eye in the eye image become horizontal.

(6) The size change processing is processing of changing a size of an image (resizing to a high resolution or a low resolution). For example, the size change processing is processing of resizing, to a high resolution or a low resolution, an eye image, an image of a pupil, or the like in such a way that an iris radius becomes a predetermined size.

(7) The inversion processing is processing of inverting an image. (8) The shear processing is processing of shear mapping an image. The shear mapping means moving, by an amount proportional to a signed distance from a certain straight line, in parallel to the straight line.

### (Advantageous Effect)

By performing normalization processing exemplified in the present modified example, an image suitable for extracting an image feature can be acquired. Thereby, an image feature suitable for recognition can be extracted. Therefore, it becomes possible to improve performance of recognition using a subject image.

### Second Example Embodiment

A functional configuration, a physical configuration, and an operation of an information processing system according to the present example embodiment are approximately similar to those of the information processing system 100 according to the first example embodiment. In the present example embodiment, a detailed configuration example of a parameter correction unit 113 is described. Moreover, a detailed example of parameter correction processing (step S143) is described.

In the present example embodiment, in order to simplify description, description overlapping with other example embodiments is omitted as appropriate.

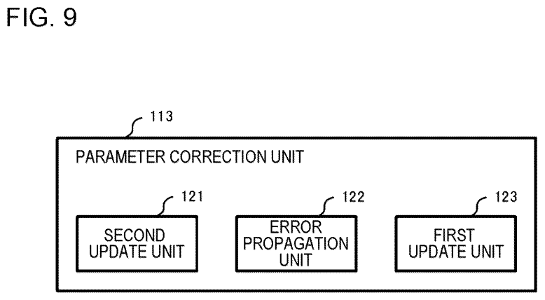

FIG. 9 is a diagram illustrating a functional configuration example of the parameter correction unit 113 according to the second example embodiment. The parameter correction unit 113 functionally includes a second update unit 121, an error propagation unit 122, and a first update unit 123.

The second update unit 121 derives a second update value, based on a gradient of a loss function L and a second gradient. The error propagation unit 122 derives a first loss gradient (∂L/∂x), based on a second loss gradient (∂L/∂y) and a normalized gradient (∂y/∂x). The first update unit 123 derives a first update value, based on the first loss gradient (∂L/∂x) and the first gradient.

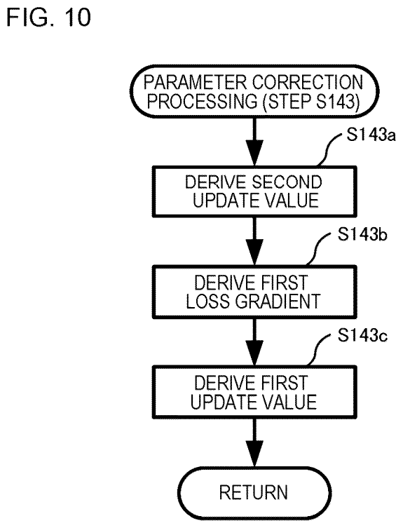

FIG. 10 is a flowchart illustrating a detailed example of the parameter correction processing (step S143) according to the second example embodiment.

The second update unit 121 derives a second update value, based on a gradient of the loss function L and the second gradient (step S143a).

The error propagation unit 122 derives a first loss gradient (∂L/∂x), based on the second loss gradient (∂L/∂y) and the normalized gradient (∂y/∂x) (step S143b). For example, the error propagation unit 122 derives a product of the second loss gradient (∂L/∂y) and the normalized gradient (∂y/∂x) as the first loss gradient (∂L/∂x).

The first update unit 123 derives a first update value, based on the first loss gradient (∂L/∂x) and the first gradient (step S143c), and returns to correction processing illustrated in FIG. 7 (step S104).

### (Advantageous Effect)

As described above, according to the present example embodiment, the gradient computation unit 112 further derives a first gradient being a local gradient in the first neural network, and a second gradient being a local gradient in the second neural network, in such a way that a loss is reduced.

The parameter correction unit 113 includes the second update unit 121, the error propagation unit 122, and the first update unit 123. The second update unit 121 derives a second update value for updating a second parameter, based on a gradient of the loss function L and the second gradient. The error propagation unit 122 derives a first loss gradient (∂L/∂x) being a gradient of a loss function for being applied to the first neural network, based on the second loss gradient (∂L/∂y) and the normalized gradient (∂y/∂x). The first update unit 123 derives a first update value for updating the first parameter, based on the first loss gradient (∂L/∂x) and the first gradient.

Thereby, similarly to the first example embodiment, the first parameter and the second parameter can be corrected simultaneously (in an end-to-end way) by utilizing a chain rate of a partial differential, in such a way as to reduce a loss derived by use of a common loss function for the first neural network and the second neural network. Since machine learning of the first neural network and the second neural network can be performed simultaneously by use of a common loss function, the first parameter and the second parameter can be corrected simultaneously in such a way that an image feature suitable for recognition can be extracted. Therefore, it becomes possible to improve performance of recognition using a subject image.

### Third Example Embodiment

In a third example embodiment, an example in which an information processing system is formed of a plurality of apparatuses is described. In the present example embodiment, in order to simplify description, description overlapping with other example embodiments is omitted as appropriate.

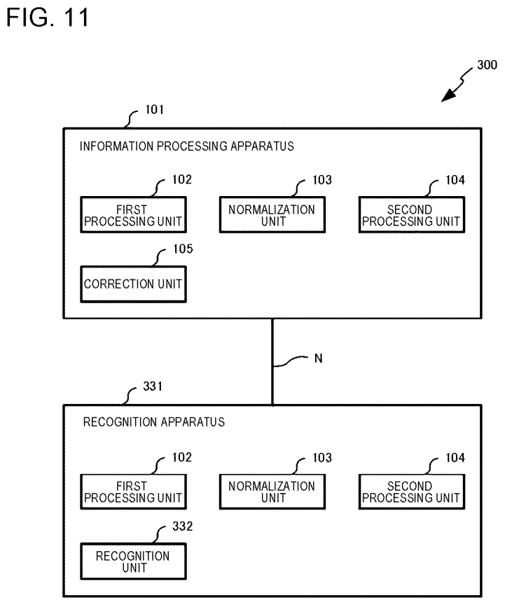

FIG. 11 is a diagram illustrating a configuration example of an information processing system 300 according to the third example embodiment. The information processing system 300 includes an information processing apparatus 101 being functionally and physically similar to that according to the first example embodiment, and a recognition apparatus 331.

The information processing apparatus 101 and the recognition apparatus 331 can transmit and receive information to and from each other via a network N wiredly, wirelessly, or via the network formed by a combination thereof by being connected to each other.

The recognition apparatus 331 functionally includes a first processing unit 102, a normalization unit 103, and a second processing unit 104 that are similar to those according to the first example embodiment, and a recognition unit 332. The recognition unit 332 performs recognition processing by use of the extracted image feature.

The recognition apparatus 331 may be physically similar to the information processing apparatus 101 according to the first example embodiment (see FIG. 6). However, a storage device 1040 of the recognition apparatus 331 preferably stores a program module for achieving a function of the recognition apparatus 331.

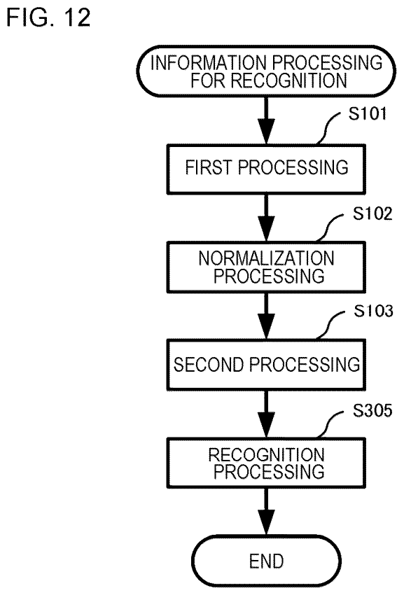

FIG. 12 is a flowchart illustrating one example of information processing for recognition according to the third example embodiment.

In information processing for recognition, the first processing unit 102, the normalization unit 103, and the second processing unit 104 of the recognition apparatus 331 execute steps S101, S102, and S103 similar to those according to the first example embodiment, respectively.

The recognition unit 332 performs recognition processing by use of an image feature extracted in step S103 (step S305).

Specifically, for example, the recognition unit 332 compares a previously registered image feature and the image feature extracted in step S103. The previously registered image feature is associated with the image feature extracted in step S103, and is, for example, an image feature of a person acquired by executing steps S101, S102, and S103 at registration by use of a human eye image (image for registration).

The recognition unit 332 discerns, based on a result of comparing an image feature, whether recognition has been successful, and outputs a result of discerning. For example, in a case where the compared image features match, the recognition unit 332 discerns that a previously registered person and a person captured in order to acquire a subject image are the same person, and that recognition has been successful. For example, in a case where the compared image features do not match, the recognition unit 332 discerns that the previously registered person is different from the person captured in order to acquire the subject image, and that recognition has been unsuccessful.

Herein, matching of image features may be completely matching of image features, or may be that a similarity degree of image features is within a previously determined range.

### (Advantageous Effect)

The present example embodiment also provides an advantageous effect similar to those according to the first example embodiment. Moreover, according to the present example embodiment, it becomes possible to perform high-performance recognition using a subject image.

### Fourth Example Embodiment

In a fourth example embodiment, another example in which an information processing system is formed of a plurality of apparatuses is described. In the present example embodiment, in order to simplify description, description overlapping with other example embodiments is omitted as appropriate.

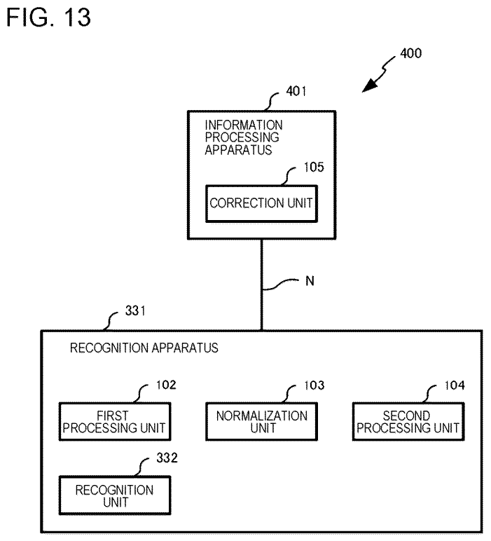

FIG. 13 is a diagram illustrating a configuration example of an information processing system 400 according to the fourth example embodiment. The information processing system 400 includes an information processing apparatus 401, and a recognition apparatus 331 being functionally and physically similar to the third example embodiment.

The information processing apparatus 401 includes a correction unit 105 functionally similar to that according to the first example embodiment.

The information processing apparatus 401 may be physically similar to the information processing apparatus 101 according to the first example embodiment (see FIG. 6). However, the storage device 1040 of the information processing apparatus 401 preferably stores a program module for achieving a function of the information processing apparatus 401.

The information processing system 400 according to the present example embodiment executes information processing similar to that according to the first example embodiment, and information processing for recognition similar to that according to the third example embodiment.

However, steps S101 to S103 in the information processing are executed by a first processing unit 102, a normalization unit 103, and a second processing unit 104 of the recognition apparatus 331, respectively.

In step S104 according to the present example embodiment, the correction unit 105 (e.g., a loss computation unit 111) acquires a result of step S103 from the recognition apparatus 331, for example, via the network N. Then, the correction unit 105 preferably executes processing similar to correction processing (step S104) according to the first example embodiment by use of an acquired result of step S103.

### (Advantageous Effect)

The present example embodiment also provides an advantageous effect similar to those according to the first example embodiment. Moreover, according to the present example embodiment, it becomes possible to perform high-performance recognition using a subject image.

### Fifth Example Embodiment

In the first example embodiment, a case where first processing is processing for detecting, in a subject image, a keypoint (e.g., an iris and a pupil) previously determined regarding a subject (e.g., an eye) has been described as an example. However, the first processing is not limited thereto.

The first processing may be, for example, super-resolution processing for generating, based on a subject image, a super-resolution image being an image with higher resolution than that of the subject image.

The first processing may be sharpening processing for generating, based on a subject image, a sharp image being an image with higher sharpness than that of a subject image. An image with high sharpness is an image in which, in a case where a subject image includes a blurred region, for example, for such a reason as being out of focus in capturing or presence of dirt on a lens for capturing, sharpness of the region is heightened.

In the present example embodiment, a case where the first processing is super-resolution processing is described as an example. In the present example embodiment, in order to simplify description, description overlapping with other example embodiments is omitted as appropriate.

The first processing according to the present example embodiment is super-resolution processing for generating, based on a subject image, a super-resolution image being an image with higher resolution than that of the subject image. In the present example embodiment, a subject image may be an eye image capturing an eye, similarly to the first example embodiment. The first output information may include a super-resolution image generated based on the eye image.

It is preferable that a normalization unit 103 performs normalization processing using a super-resolution image being an image included in first output information, and generates a normalized image relating to an eye image.

Specifically, for example, the normalization unit 103 preferably performs normalization processing using an iris position and a super-resolution image, and generates a normalized image relating to an eye image. As one example of the normalization processing, processing of cutting out an image of an iris, based on an iris position, from a super-resolution image acquired by performing super-resolution processing on a subject image can be cited.

There are various methods for the normalization unit 103 to acquire an iris position.

The normalization unit 103 may acquire an iris position, for example, based on an input of a user.

Moreover, for example, an information processing system (e.g., an information processing apparatus 101) may further include a third processing unit that performs third processing using a third neural network with a subject image as an input. The third processing in this case may be eye detection processing for detecting an iris in an eye image. Third output information being a result of the third processing preferably includes a position of the iris. Similarly to a first parameter, a correction unit 105 may correct a third parameter, based on information relating to a normalized image. The third parameter is a parameter used in the third neural network.

Except for these, a functional configuration and an operation of the information processing system according to the present example embodiment may be similar to, for example, those of the first example embodiment and the like. Moreover, a physical configuration of the information processing system according to the present example embodiment may be similar to, for example, those of the first example embodiment and the like.

### (Advantageous Effect)

According to the present example embodiment, the first processing is super-resolution processing for generating, based on a subject image, a super-resolution image being an image with higher resolution than that of the subject image.

Thereby, since an image suitable for extracting an image feature can be acquired from a subject image, an image feature suitable for recognition can be extracted. Therefore, it becomes possible to improve performance of recognition using a subject image.

According to the present example embodiment, a subject image is an eye image capturing an eye. The first output information includes a super-resolution image generated based on the eye image. The normalization unit 103 performs normalization processing using a super-resolution image, and generates a normalized image relating to the eye image.

Thereby, since an image suitable for extracting an image feature can be acquired from a subject image, an image feature suitable for iris recognition can be extracted. Therefore, it becomes possible to improve performance of recognition using a subject image.

According to the present example embodiment, the first processing is sharpening processing for generating, based on a subject image, a sharp image being an image with higher sharpness than that of the subject image.

Thereby, since an image suitable for extracting an image feature can be acquired from a subject image, an image feature suitable for recognition can be extracted. Therefore, it becomes possible to improve performance of recognition using a subject image.

### Sixth Example Embodiment

In the sixth example embodiment, an example including mask processing of excluding a previously determined exclusion region from an image is described. In the present example embodiment, in order to simplify description, description overlapping with other example embodiments is omitted as appropriate.

### (Configuration of Information Processing System 600)

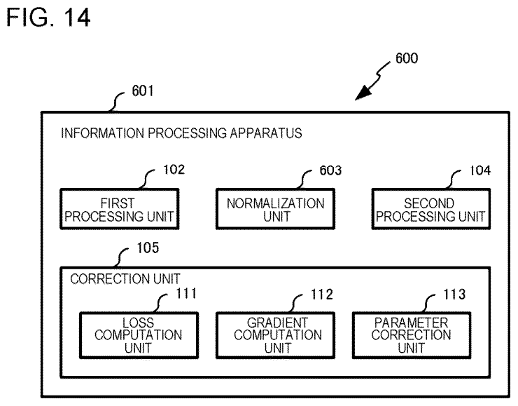

FIG. 14 is a diagram illustrating a configuration example of an information processing system 600 according to a sixth example embodiment. The information processing system 600 includes an information processing apparatus 601. The information processing apparatus 601 includes a first processing unit 102, a second processing unit 104, and a correction unit 105 that are functionally similar to those according to the first example embodiment, and a normalization unit 603 replacing the normalization unit 103 according to the first example embodiment.

Similarly to the first example embodiment, the normalization unit 603 preferably performs normalization processing using first output information being a result of the first processing, and generates a normalized image relating to a subject image. The normalization processing includes normalization processing similar to that according to the first example embodiment, and mask processing for excluding a previously determined exclusion region from an image.

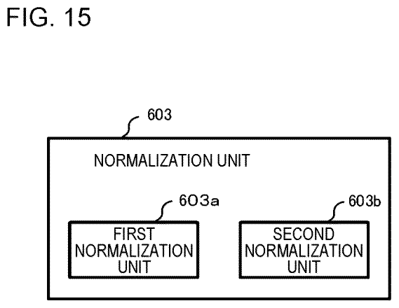

FIG. 15 is a diagram illustrating a functional configuration example of the normalization unit 603 according to the sixth example embodiment. The normalization unit 603 includes a first normalization unit 603a and a second normalization unit 603b.

The first normalization unit 603a performs first normalization processing. The first normalization processing is, for example, mask processing for excluding a previously determined exclusion region from a subject image. The previously determined exclusion region is, for example, a region indicating at least one of an eyelid and an eyelash.

The second normalization unit 603b performs second normalization processing on a subject image from which an exclusion region has been excluded. The second normalization processing is, for example, normalization processing similar to that according to the first example embodiment.

The information processing apparatus 601 may be physically similar to the information processing apparatus 101 according to the first example embodiment (see FIG. 6).

### (Operation of Information Processing System 600)

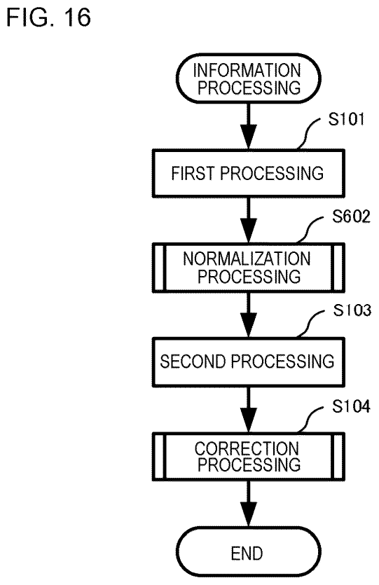

FIG. 16 is a flowchart illustrating one example of information processing according to the sixth example embodiment. The first processing unit 102 performs step S101 similar to that according to the first example embodiment.

The normalization unit 603 performs normalization processing using first output information being to a result of first processing, and generates a normalized image relating to a subject image (step S602).

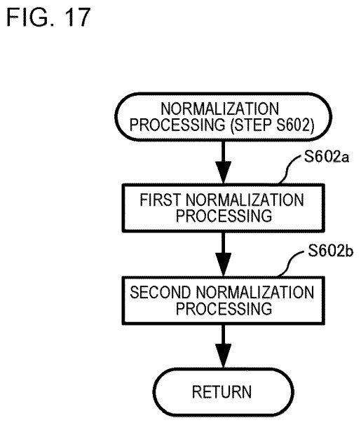

FIG. 17 is a flowchart illustrating one example of normalization processing (step S602) according to the sixth example embodiment.

The first normalization unit 603a performs first normalization processing (step S602a).

The first normalization processing is, for example, mask processing for excluding a previously determined exclusion region indicating at least one of an eyelid, an eyelash, and the like from a subject image, as described above.

The second normalization unit 603b performs second normalization processing on the subject image on which the first normalization processing has been performed in step S602a (step S602b).

The second normalization processing is, for example, normalization processing similar to that according to the first example embodiment.

In other words, the second normalization unit 603b cuts out, based on an iris position included in the first output information, for example, an image of an iris from the subject image from which the exclusion region has been excluded. Then, the second normalization unit 603b performs expansion processing on, for example, the image of the iris that has been cut out.

Note that, the second normalization processing may be at least one of (1) expansion processing, (2) cutout processing, (3) scale conversion processing, (4) parallel movement processing, (5) rotation processing, (6) size change processing, (7) inversion processing, and (8) shear processing, as described in the first modified example.

The second normalization unit 603b executes step S602b, and then returns to the information processing illustrated in FIG. 16.

FIG. 16 is referred to. The second processing unit 104 and the correction unit 105 respectively execute steps S103 and S104 similar to those according to the first example embodiment. Then, the correction unit 105 ends the information processing.

### (Advantageous Effect)

According to the present example embodiment, the normalization processing includes mask processing of excluding a previously determined exclusion region from a subject image.

By performing normalization processing including mask processing, an image suitable for extracting an image feature can be acquired. Thereby, an image feature suitable for recognition can be extracted. Therefore, it becomes possible to improve performance of recognition using a subject image.

According to the present example embodiment, a subject image is an eye image capturing an eye. A previously determined exclusion region is a region indicating at least one of an eyelid and an eyelash.

By performing normalization processing including such mask processing, an image suitable for extracting an image feature can be acquired. Thereby, an image feature suitable for iris recognition can be extracted. Therefore, it becomes possible to improve performance of recognition using a subject image.

The example embodiments and the modified examples of the present invention have been described above with reference to the drawings, but are exemplifications of the present invention, and various configurations other than those described above can also be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, the example embodiments and the modified examples described above can be combined to an extent that content does not contradict.

Some or all of the above-described example embodiments can also be described as, but are not limited to, the following supplementary notes.

1. An information processing system including:
a first processing unit that performs first processing using a first neural network with a subject image as an input;
a normalization unit that performs normalization processing using first output information being a result of the first processing, and generates a normalized image relating to the subject image;
a second processing unit that performs second processing using a second neural network with the normalized image as an input, and extracts an image feature relating to the normalized image; and
a correction unit that corrects, based on information relating to the normalized image, a first parameter being a parameter used in the first neural network.
   2. The information processing system according to supplementary note 1, wherein the normalization processing includes processing of nonlinearly normalizing the subject image or an image included in the first output information.
   3. The information processing system according to supplementary note 1 or 2, wherein
the information relating to the normalized image includes a normalized gradient being a local gradient in the normalization processing, and
the correction unit includes
a gradient computation unit that derives the normalized gradient, based on the normalized image, and
a parameter correction unit that corrects the first parameter, based on the normalized gradient.
   4. The information processing system according to supplementary note 3, wherein
the parameter correction unit further corrects a second parameter being a parameter used in the second neural network, based on a second gradient being a local gradient in the second neural network.
   5. The information processing system according to supplementary note 4, wherein
the correction unit further includes a loss computation unit that derives a loss function for computing loss based on an extracted image feature and correct answer data, and
the gradient computation unit derives the normalized gradient, based on the normalized image, in such a way that the loss is reduced.
   6. The information processing system according to supplementary note 5, wherein
the gradient computation unit further derives a first gradient being a local gradient in the first neural network, and a second gradient being a local gradient in the second neural network, in such a way that the loss is reduced, and
the parameter correction unit includes
a second update unit that derives a second update value for updating a second parameter, based on a gradient of the loss function and the second gradient,
an error propagation unit that derives a first loss gradient being a gradient of a loss function for being applied to the first neural network, based on a second loss gradient being a gradient of a loss function for being applied to the second neural network, and the normalized gradient, and
a first update unit that derives a first update value for updating the first parameter, based on the first loss gradient and the first gradient.
   7. The information processing system according to any one of supplementary notes 1 to 6, wherein
the subject image is an eye image capturing an eye, and
the first processing is eye detection processing for detecting an iris in the eye image.
   8. The information processing system according to supplementary note 7, wherein
the first output information includes a position of the detected iris, and
the normalization unit performs normalization processing using a position of the detected iris, and generates a normalized image relating to an iris included in the eye image.
   9. The information processing system according to any one of supplementary notes 1 to 5, wherein
the first processing is super-resolution processing for generating, based on the subject image, a super-resolution image being an image with higher resolution than that of the subject image.
   10. The information processing system according to supplementary note 9, wherein
the subject image is an eye image capturing an eye,
the first output information includes the super-resolution image generated based on the eye image, and
the normalization unit performs normalization processing using the super-resolution image, and generates a normalized image relating to the eye image.
   11. The information processing system according to any one of supplementary notes 1 to 5, wherein
the first processing is sharpening processing for generating, based on the subject image, a sharp image being an image with higher sharpness than that of the subject image.
   12. The information processing system according to any one of supplementary notes 1 to 11, wherein
the normalization processing includes at least one of (1) expansion processing of converting an annular image into a rectangular image, (2) cutout processing of cutting out an image of a region of interest from an image, (3) scale conversion processing of converting an image in such a way that a length of a previously determined place has a predetermined relationship in relation to the image, (4) parallel movement processing of moving an image in parallel, (5) rotation processing of rotating an image, (6) size change processing of changing a size of an image, (7) inversion processing of inverting an image, and (8) shear processing of shear mapping an image.
   13. The information processing system according to any one of supplementary notes 1 to 12, wherein
the normalization processing includes mask processing for excluding a previously determined exclusion region from the subject image.
   14. The information processing system according to supplementary note 13, wherein
the subject image is an eye image capturing an eye, and
the previously determined exclusion region is a region indicating at least one of an eyelid and an eyelash.
   15. An information processing method including,
by one or more computers:
performing first processing using a first neural network with a subject image as an input;
performing normalization processing using first output information being a result of the first processing, and generating a normalized image relating to the subject image;
performing second processing using a second neural network with the normalized image as an input, and extracting an image feature relating to the normalized image; and
correcting, based on information relating to the normalized image, a first parameter being a parameter used in the first neural network.
   16. A storage medium recording a program for causing one or more computers to execute:
performing first processing using a first neural network with a subject image as an input;
performing normalization processing using first output information being a result of the first processing, and generating a normalized image relating to the subject image;
performing second processing using a second neural network with the normalized image as an input, and extracting an image feature relating to the normalized image; and
correcting, based on information relating to the normalized image, a first parameter being a parameter used in the first neural network.

Reference Signs List

| | |
|---|---|
| 100, 300, 400, 600 | Information processing system |
| 101, 401, 601 | Information processing apparatus |
| 102 | First processing unit |
| 103, 603 | Normalization unit |
| 104 | Second processing unit |
| 105 | Correction unit |
| 111 | Loss computation unit |
| 112 | Gradient computation unit |
| 113 | Parameter correction unit |
| 121 | Second update unit |
| 122 | Error propagation unit |
| 123 | First update unit |
| 331 | Recognition apparatus |
| 332 | Recognition unit |
| 603a | First normalization unit |
| 603b | Second normalization unit |

What is claimed is:

1. An information processing system comprising:
a memory configured to store instructions; and
a processor configured to execute the instructions to:
perform first processing using a first neural network with a subject image as an input;
perform normalization processing using first output information being a result of the first processing, and generates a normalized image relating to the subject image;
perform second processing using a second neural network with the normalized image as an input, and extracts an image feature relating to the normalized image; and
correct, based on information relating to the normalized image, a first parameter being a parameter used in the first neural network.

2. The information processing system according to claim 1, wherein
the normalization processing includes processing of nonlinearly normalizing the subject image or an image included in the first output information.

3. The information processing system according to claim 1, wherein
the information relating to the normalized image includes a normalized gradient being a local gradient in the normalization processing, and
correcting the first parameter includes
deriving the normalized gradient, based on the normalized image, and
correcting the first parameter, based on the normalized gradient.

4. The information processing system according to claim 3, wherein
correcting the first parameter further includes correcting a second parameter being a parameter used in the second neural network, based on a second gradient being a local gradient in the second neural network.

5. The information processing system according to claim 4, wherein
correcting the first parameter further includes deriving a loss function for computing loss based on an extracted image feature and correct answer data, and
deriving the normalized gradient, based on the normalized image, in such a way that the loss is reduced.

6. The information processing system according to claim 5, wherein
deriving the normalized gradient further includes deriving a first gradient being a local gradient in the first neural network, and a second gradient being a local gradient in the second neural network, in such a way that the loss is reduced, and
correcting the first parameter further includes
deriving a second update value for updating a second parameter, based on a gradient of the loss function and the second gradient,
deriving a first loss gradient being a gradient of a loss function for being applied to the first neural network, based on a second loss gradient being a gradient of a loss function for being applied to the second neural network, and the normalized gradient, and
deriving a first update value for updating the first parameter, based on the first loss gradient and the first gradient.

7. The information processing system according to claim 1, wherein
the subject image is an eye image capturing an eye, and
the first processing is eye detection processing for detecting an iris in the eye image.

8. The information processing system according to claim 7, wherein
the first output information includes a position of the detected iris, and
the normalization processing further uses a position of the detected iris, and includes generating a normalized image relating to an iris included in the eye image.

9. The information processing system according to claim 1, wherein
the first processing is super-resolution processing for generating, based on the subject image, a super-resolution image being an image with higher resolution than that of the subject image.

10. The information processing system according to claim 9, wherein
the subject image is an eye image capturing an eye,
the first output information includes the super-resolution image generated based on the eye image, and
the normalization processing further uses the super-resolution image, and includes generating a normalized image relating to the eye image.

11. The information processing system according to claim 1, wherein
the first processing is sharpening processing for generating, based on the subject image, a sharp image being an image with higher sharpness than that of the subject image.

12. The information processing system according to claim 1, wherein
the normalization processing includes at least one of (1) expansion processing of converting an annular image into a rectangular image, (2) cutout processing of cutting out an image of a region of interest from an image, (3) scale conversion processing of converting an image in such a way that a length of a previously determined place has a predetermined relationship in relation to the image, (4) parallel movement processing of moving an image in parallel, (5) rotation processing of rotating an image, (6) size change processing of changing a size of an image, (7) inversion processing of inverting an image, and (8) shear processing of shear mapping an image.

13. The information processing system according to claim 1, wherein
the normalization processing includes mask processing for excluding a previously determined exclusion region from the subject image.

14. (canceled)

15. An information processing method comprising,
by one or more computers:
performing first processing using a first neural network with a subject image as an input;
performing normalization processing using first output information being a result of the first processing, and generating a normalized image relating to the subject image;
performing second processing using a second neural network with the normalized image as an input, and extracting an image feature relating to the normalized image; and
correcting, based on information relating to the normalized image, a first parameter being a parameter used in the first neural network.

16. A non-transitory computer readable medium recording a program for causing one or more computers to execute:
performing first processing using a first neural network with a subject image as an input;
performing normalization processing using first output information being a result of the first processing, and generating a normalized image relating to the subject image;
performing second processing using a second neural network with the normalized image as an input, and extracting an image feature relating to the normalized image; and
correcting, based on information relating to the normalized image, a first parameter being a parameter used in the first neural network.
